(19) United States
(12) Patent Application Publication
(10) Pub. No.: US 2019/0291639 A1
(43) Pub. Date: Sep. 26, 2019

(54) SUPPORT FOR HEARING-IMPAIRED DRIVERS

(71) Applicant: ZF Friedrichshafen AG, Friedrichshafen (DE)

(72) Inventors: Lucas Hanson, Friedrichshafen (DE); Andrea Loi, Schweinfurt (DE); Anja Petrich, Kressbronn-Gohren (DE); Debora Lovison, Friedrichshafen (DE); Julian Fieres, Schweinfurt (DE); Florian Ade, Langenargen (DE)

(73) Assignee: ZF Friedrichshafen AG, Friedrichshafen (DE)

(21) Appl. No.: 16/358,256

(22) Filed: Mar. 19, 2019

(30) Foreign Application Priority Data
Mar. 20, 2018 (DE) DE102018204258.6

(51) Int. Cl. B60Q 9/00; G05D 1/00; G09B 21/00

(52) U.S. Cl. CPC B60Q 9/00; G09B 21/009; G05D 1/0088

(57) ABSTRACT

The invention relates to an evaluation device (10) for a vehicle (1) for assisting a hearing impaired vehicle driver (2), comprising an input interface (11) for receiving at least one ambient noise, wherein the evaluation device (10) is configured to determine at least one position of the sound source in relation to the vehicle (1) based on the ambient noise, to anticipate a dangerous situation based on the movement of the vehicle (1) in relation to the sound source, and to generate a signal for the dangerous situation, and a first output interface (12) configured to output the signal such that the hearing impaired vehicle driver (2) can perceive it, in order to assist the vehicle driver (2) in reacting to the dangerous situation. The invention also relates to an assistance system (20), a method, and a computer program (30) for assisting a hearing impaired vehicle driver (2).

### FIELD

The invention relates to an evaluation device for a vehicle for assisting a hearing impaired vehicle driver according to claim 1. The invention also relates to an assistance system for a hearing impaired vehicle driver according to claim 8. Moreover, the invention relates to the use of the assistance system according to the invention according to claim 10. Furthermore, the invention relates to a method for assisting a hearing impaired vehicle driver while driving a vehicle according to claim 11. The invention also relates to a computer program for assisting a hearing impaired vehicle driver according to claim 15.

### DESCRIPTION OF RELATED ART

Hearing impaired persons are not allowed to simply drive a vehicle, in particular a street vehicle. Because of the hearing impairment, there is a risk that the hearing impaired individual will fail to hear sounds in the surroundings, in particular sounds relevant to traffic associated with dangerous situations, e.g. honking of other vehicles' horns, sirens from service or rescue vehicles, or sounds made by non-automobile road users. Consequently, hearing impaired individuals have a limited ability to perceive dangerous traffic situations.

Hearing assistance for hearing impaired individuals, such as hearing aids, are known from the prior art. Nevertheless, a hearing impaired individual must submit certification in Germany, e.g. an opinion from an ear, nose, and throat doctor, confirming that the individual can drive safely, in order to obtain a driving license. In other countries, the guidelines are more restricting. Even if a hearing impaired individual obtains permission to drive, there is the danger that he will not perceive all of the ambient sounds.

### SUMMARY

The fundamental objective of the invention is to assist vehicle drivers in perceiving ambient noise, in order to be able to react to dangerous situations.

This object is achieved with an evaluation device for a vehicle for assisting a hearing impaired vehicle driver that has the features of claim 1. The object is also achieved by an assistance system for hearing impaired vehicle drivers that has the features of claim 8. Moreover, the object is achieved by the use of the assistance system according to the invention in accordance with claim 10. Furthermore, the object is achieved by a method for assisting a hearing impaired vehicle driver while driving a vehicle that has the features of claim 11. The object is also achieved by means of a computer program for assisting a hearing impaired vehicle driver that has the features of claim 15.

Further developments and advantageous embodiments are described in the dependent claims.

The evaluation device according to the invention, for a vehicle, for assisting a hearing impaired vehicle driver, comprises a first input interface for registering at least one ambient sound. The evaluation device is configured to determine at least one position of the sound source in relation to the vehicle, based on the ambient sound. Furthermore, the evaluation device is configured to determine the existence of a dangerous situation, based on a movement of the vehicle in relation to the sound source, and to generate a signal for the dangerous situation. The evaluation device also has an output interface that is configured to output the signal to the hearing impaired vehicle driver in order to assist the vehicle driver in reacting to the dangerous situation.

An evaluation device is a device that processes the information it receives, and outputs the results. In particular, an evaluation device comprises an electronic circuitry, e.g. a central processing unit.

The vehicles are land vehicles, in particular.

Hearing impairment refers to restrictions in the acoustic perceptions of a person. Hearing impairment comprises restrictions with regard to certain volumes, and limitations regarding certain frequency ranges. The degrees of hearing impairment comprise
hearing loss, i.e. loss of hearing at a volume of substantially 50 decibels,
residual hearing, defined by hearing loss starting at volumes of substantially 90 decibels, and
deafness or anacousia, i.e. hearing loss at volumes of more than 120 decibels.

An interface is a mechanism between at least two functional units, where an exchange of logical variables, e.g. data or physical variables, e.g. electrical signals, takes places, either unidirectionally or bidirectionally. The exchange can be analog or digital. The exchange can furthermore be wired or wireless.

Ambient sounds are sounds in the surroundings of the vehicle. Traffic noises, e.g. the honking of vehicle horns, sirens from service and rescue vehicles and sounds from non-automobile road users comprise traffic noises. Sounds are sound events that can be perceived by people and/or sensors, e.g. sound converters, in particular microphones. The surroundings of the vehicle comprise the space in which objects act on the vehicle and are able to affect the state of the vehicle. In simple terms, the surroundings comprise a circle, the center of which is the vehicle. The radius of this circle depends on the respective situation.

A dangerous situation comprises, e.g. a vehicle in a passing lane of a highway overtaking the vehicle driven by the hearing impaired driver. The vehicle driven by the hearing impaired driver may also be in the passing lane, or could make a lane change to the passing lane. If a hearing impaired driver is not visually monitoring the space behind his vehicle, he will not detect the danger situation resulting from an overtaking vehicle, because he will not hear the sound of a horn due to his hearing impairment. The evaluation device, however, detects the sound of the horn, and evaluates it with regard to the movement of the vehicle of the hearing impaired driver in relation to the position of the sound of the horn. The evaluation device outputs a signal that the hearing impaired driver can perceive, in order to make the driver aware of the dangerous situation. In response, the hearing impaired driver can change lanes, or continue to drive in his lane. As a result, the danger of the overtaking vehicle is avoided. Dangerous situations are not only situations posing danger to the hearing impaired driver. Dangerous situations also comprise situations in which the hearing impaired driver poses a danger to a third party.

Non-visually perceivable information is recorded and evaluated with the evaluation device according to the invention. This information, preferably in conjunction with visually perceivable information, improves perception of a current surroundings of the vehicle. This is of particular advantage for hearing impaired drivers. The evaluation device assists the hearing impaired driver in terms of acoustic perception. Without the evaluation device, the acoustic perception of the hearing impaired individual is limited.

The evaluation device is preferably configured to execute a computer program. The computer program comprises software code segments for determining a position of a sound source in relation to the vehicle, based on the ambient noise, in order to anticipate a dangerous situation, based on the movement of the vehicle in relation to the sound source, and to generate a signal indicating the dangerous situation.

Software is an umbrella term for programs and associated data. The complement to software is hardware. Hardware comprises the mechanical and electrical components of a data processing system.

According to a preferred embodiment of the invention, the first input interface is an interface for at least one microphone that can be placed on the vehicle. This means that the first interface is an audio interface. The first interface is preferably an interface for four microphones that can be placed on the vehicle, wherein it is particularly preferred that a first microphone is placed in the front of the vehicle, a second microphone is placed in the rear of the vehicle, a third microphone is placed on a first side of the vehicle, and a fourth microphone is placed on a second side of the vehicle.

The microphones that can be placed on the vehicle are microphones that are suitable for use with automobiles, i.e. microphones that are particularly weather resistant and functionally reliable. These microphones preferably have filters and/or boosters, such that they are responsive to ambient noise. With a microphone on each side of the vehicle, i.e. at the front, back, left and right, ambient noise can be advantageously detected from all directions in relation to the vehicle. The respective microphones are preferably directional microphones.

The first output interface is preferably an interface, preferably a user interface, that outputs the signal for visual and/or tactile perception.

A user interface, referred to in English as a “human machine interface,” is the point where a human comes in contact with a machine. User interfaces in vehicles comprise, in particular, the dashboard, the central console, the gearshift lever, the steering wheel and/or the gas pedal. The windscreen can also be used as a display, and thus for visual perception of information, such that it can also be used as a user interface. Normally, the region where the vehicle driver looks through the windshield is used for displaying information, referred to in English as a “head up display.” It is also conceivable for the entire surface of the windshield to be used as a user interface. Preferably, the technologies relating to augmented reality, referred to in English as “augmented reality,” can be used for displaying information.

By way of example, the sound of a siren from an overtaking fire truck, recorded and evaluated by the evaluation device, is indicated visually in a head up display by a red, spinning blinking light, preferably with a fire symbol. This means that the signal is the red, spinning blinking light, which indicates the sound of the siren such that the hearing impaired driver can be made aware of it. The hearing impaired driver, who does not hear the sound of the siren, is then informed by this signal that a fire truck is approaching. The head up display can also be used to indicate the distance to the overtaking fire truck.

At the same time, the steering wheel temperature can be raised, for example. This increase in temperature is perceived by the hearing impaired driver, touching the steering wheel, with his sense of touch, thus in a tactile manner. The temperature increase is intuitively associated with fire by the hearing impaired driver. Moreover, a honking by an overtaking vehicle can be perceived by vibrations in the steering wheel.

The visual and/or tactile perception of the ambient noise is of particular advantage for deaf vehicle drivers.

It is particularly advantageous for hearing impaired individuals that according to another embodiment of the invention, the first output interface is an interface that outputs the signal for acoustic perception. As a result, the hearing impaired driver can hear the ambient noise that he would no longer be able to perceive acoustically inside the vehicle. The signal is simply an amplification of the ambient noise.

According to an advantageous further development of the invention, the computer program is an artificial neural network that is trained to generate a signal for dangerous situations. The evaluation device is configured to forward propagate the artificial neural network with the at least one ambient noise.

An artificial neural network is an algorithm executed on an electronic circuitry, and which is programmed using the neural network of the human brain as a model. The functional units of an artificial neural network are artificial neurons, the output of which is evaluated in general as a value of an activation function via a weighted sum of the inputs plus a systematic error, the so-called bias. By testing numerous predetermined inputs with various weighting factors and/or activation functions, artificial neural networks are trained in a manner similar to that of the human brain. The training of an artificial neural network using predetermined inputs is referred to as machine learning. A portion of the machine learning is deep learning, in which a series of hierarchical layers of neurons, so-called hidden layers, are used in order to carry out the process of machine learning. An artificial neural network with numerous hidden layers is a deep neural network. Examples of artificial neural networks are perceptrons and convolutional or recurrent neural networks. Connections between neurons are evaluated with weighting factors. Forward propagation means that information is supplied to the input layer of the artificial neural network, which then passes through the subsequent layers, and is output at the output layer. Backward propagation means that information is input at the output layer, and output at the input layer. Through successive backward propagation of the error from the output layer into the preceding layer until reaching the input layer, the errors in the respective layers are obtained. The errors are functions of the weighting factors. By minimizing the errors in the training phase, the weighting factors are modified. As a result, when an input is input again, the desired output is approached. Backward propagation is described comprehensively in Michael A. Nielsen, Neural Networks and Deep Learning, Determination Press, 2015.

A trained artificial neural network has the advantage that is reacts to new information in targeted manner. The trained artificial neural network recognizes the significance of an ambient noise, and the associated danger situation. If a siren is detected as an ambient noise, the trained artificial neural network knows that a rescue vehicle is close by.

The evaluation device preferably comprises a second output interface for output the signal to a vehicle control device for an at least partially automated control of the vehicle.

The vehicle control device regulates the longitudinal and/or transverse control of the vehicle. The partially automated control of he vehicle improves the assistance to the vehicle driver in reacting to a dangerous situation, in particular when there is very little time left in which to react.

In a particularly preferred further development of the invention, the evaluation device comprises a second input interface for receiving data from at least one surroundings detection sensor. The evaluation device is configured to combine the data from the at least one surroundings detection sensor with the at least one ambient noise with regard to the perception of the surroundings of the vehicle.

Surrounding detection sensors comprise cameras, lidar and/or radar sensors. Driver assistance systems perceive the surroundings of a vehicle with surroundings detection sensors. An improved model of the surroundings is obtained by combining the ambient noise with the data from a surroundings detection sensor. If, for example, the evaluation device receives the sound of a siren via the first input interface, and an image of an overtaking fire truck via the second input interface, the signal generated by the evaluation device is output via the output interface as an image of the fire truck, with a subtitle, wherein the subtitle indicates the sequence of the sounds of the siren, e.g. as “ta-tü-ta-ta.

The assistance system according to the invention for hearing impaired vehicle drivers, comprises at least one microphone that can be placed on a vehicle, for detecting at least one ambient noise. Furthermore, the assistance system comprises an evaluation device according to the invention. Moreover, the assistance system comprises a user device for the vehicle. The first input interface of the evaluation device receives the ambient sound recorded by the microphone. The first output interface of the evaluation device outputs the signal to the user interface, in order to assist the vehicle driver in reacting to the danger situation.

A user interface is a dashboard, central console, gearshift lever, steering wheel, gas pedal and/or windshield.

The assistance system has the advantages of the evaluation device according to the invention. As a result, the invention provides an overall system for assisting hearing impaired vehicle drivers when driving a vehicle.

The user interface is advantageously a display device, preferably an infotainment system and/or a head up display, a touch device, preferably a steering wheel and/or gas pedal, and/or an audio device, preferably a speaker and/or speaker system. As a result, the assistance system comprises means for perceiving ambient noises visually, tactilely, and acoustically. Deaf vehicle drivers benefit from the visual and/or tactile perception. Vehicle drivers that are hard of hearing benefit from the acoustic perception.

The use of an assistance system in a vehicle also belongs to the invention. This results in the advantages of the assistance system according to the invention in a vehicle.

The method for assisting a hearing impaired vehicle driver while driving a vehicle comprises the following steps:
detecting at least one ambient noise from the surroundings of the vehicle,
determining at least one position of the sound source in relation to the vehicle, based on the ambient noise,
anticipating a dangerous situation based on the movement of the vehicle in relation to the sound source,
generating the signal for the hearing impaired vehicle driver, in order to assist the driver in reacting to the dangerous situation.

This method assists hearing impaired vehicle drivers in perceiving ambient noises, and assists the driver in reacting to a dangerous situation.

Advantageously, a direction of movement of the sound source in relation to the vehicle is determined on the basis of the ambient noise. The direction of movement can be determined, for example, based on a Doppler shift in the frequencies of the ambient noise. The determination of the direction of movement improves reactions to a dangerous situation. In particular, by knowing the direction of movement of an approaching sound source, it is possible to intentionally avoid this sound source.

The signal is preferably output to a vehicle control device, and the vehicle control device is then able to at least partially automatically control the vehicle. In particular in dangerous situations, in which there is very little time to react, the assistance to the driver in reacting to a dangerous situation is improved by the partially automated control of the vehicle.

An evaluation device according to the invention or an assistance system according to the invention is preferably used for executing the method.

The computer program according to the invention for assisting a hearing impaired vehicle driver is designed to be uploaded to the memory of a computer. The computer program comprises software code segments, with which the steps of the method according to the invention are carried out when the computer program runs on the computer.

Computer programs normally comprise a sequence of commands, in response to which, the hardware executes a specific process producing a specific technological result when the program has been installed. When the program is used on a computer, the computer program produces a technological effect, specifically the generation of a signal based on an ambient noise, in order to indicate the ambient noise to a hearing impaired individual.

A memory is a medium for storing data.

The invention allows hearing impaired vehicle drivers to perceive ambient noise, in particular relevant traffic sounds, in order to avoid dangerous situations.

### BRIEF DESCRIPTION OF THE DRAWINGS

The invention shall be explained in greater detail based on the figures. Therein:

FIG. 1 shows a schematic illustration of a vehicle with an exemplary embodiment of the evaluation device according to the invention,

FIG. 2 shows a schematic illustration of an exemplary embodiment of an assistance system according to the invention,

FIG. 3 shows a schematic illustration of an exemplary embodiment of a computer program according to the invention, and

FIG. 4 shows the sequence of the method according to the invention.

### DETAILED DESCRIPTION

Identical reference symbols refer to identical components or components with similar functions in the figures.

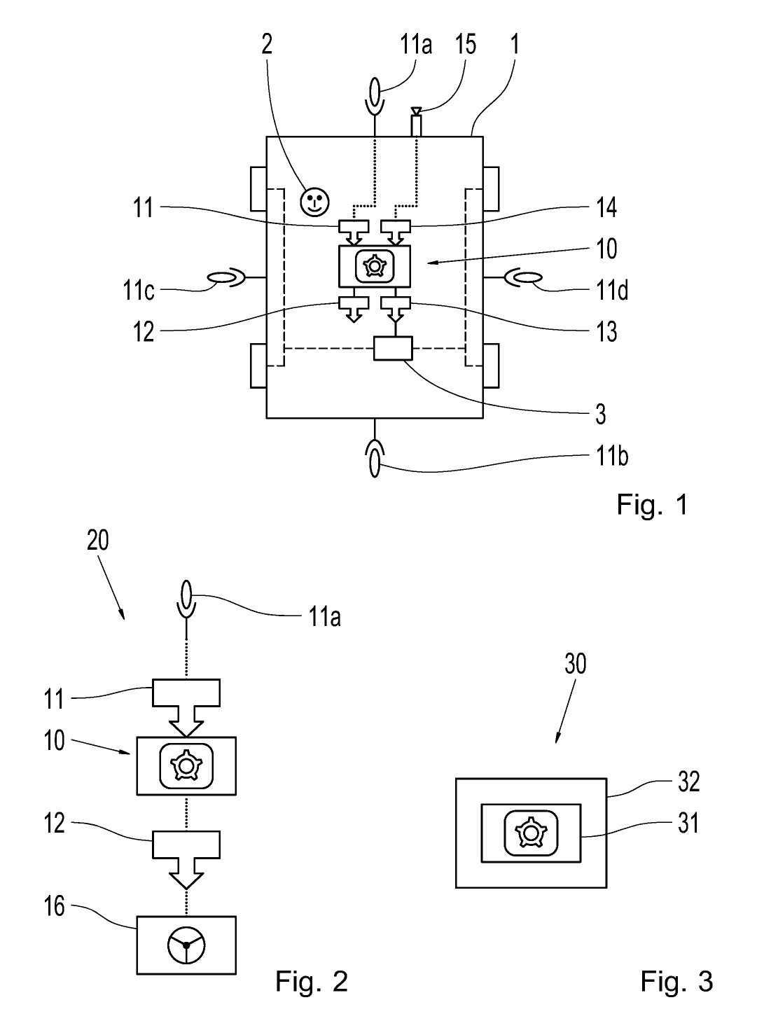

FIG. 1 shows a vehicle 1. The vehicle 1 is a passenger car. The vehicle is driven by a deaf driver 2. One microphone is mounted on each side of the vehicle 1. The microphones are directional microphones and suitable for use with automobiles. In particular, the microphones are weather resistant and function reliably. A first microphone 11a is located on the front of the vehicle 1, in order to record ambient noise coming from the front. A second microphone 11b is located on the back of the vehicle, in order to record ambient noises from the back. A third microphone 11c is located on the left side of the vehicle 1, in order to record ambient noise on the left. A fourth microphone 11d is located on the right side of the vehicle, in order to record ambient noise from the right.

The microphones 11a, 11b, 11c, 11d transmit the recorded ambient noise to a first input interface 11 of an evaluation device 10. The first input interface 11 is an audio interface.

The evaluation device 10 is a processor that executes a computer program. The evaluation device 10 can be a central processing unit for the vehicle 1, or integrated in a central processing unit for the vehicle 1. The computer program contains the architecture of an artificial neural network. The artificial neural network is trained to output the type of sound source and a possibly dangerous situation, based on this sound source in relation to the vehicle 1, by means of a signal when an ambient noise is input. The signal is output such that a deaf vehicle driver 2 can perceive it via a first output interface 12, e.g. visually via a head up display.

The evaluation device 10 comprises a second input interface 14. Data from a surroundings detection sensor 15, in the form of a camera for a vehicle assistance system, are input to the evaluation device 10 via the second input interface 14. The trained artificial neural network combines the recorded ambient noise with the image data from the surroundings detection sensor 15. As a result, a visual recording of the surroundings by the surroundings detection sensor 15 is combined with the acoustic recordings of the surroundings by the microphones 11a, 11b, 11c, and 11d. This combination, or fusion, results in an improved sensor-based perception of the surroundings, because in addition to visual information, non-visual information is also evaluated.

The evaluation device 10 also has a second output interface 13. The second output interface is connected to a vehicle control device 3. The signal generated by the evaluation device 10 is transmitted to the vehicle control device 3 via the second output interface 13. As a result, the vehicle 1 can be controlled by the vehicle control device 3 in response to the ambient noise.

An assistance system 20 is shown in FIG. 2. The assistance system 20 comprises a first microphone 11a, the evaluation device 10 with a first input interface 11 and a first output interface 12, and a user device 16. The user device 16 is a steering wheel. The deaf drive 2 can perceive an ambient noise via the user device 16 by means of the assistance system 20 through his sense of touch.

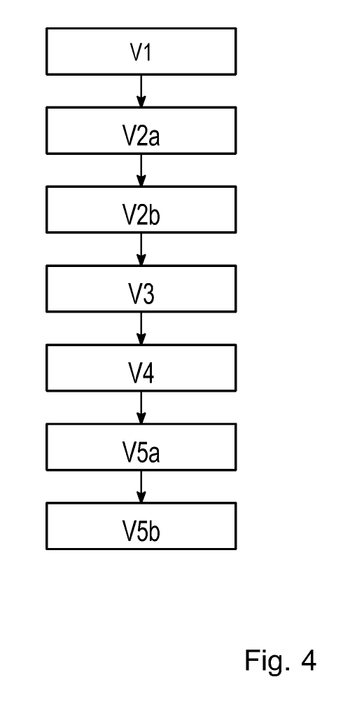

FIG. 3 shows a computer program 30 that is executed in a memory 31 of a computer 32. When the computer 32 is running, the computer program executes steps V1 to V5a of the method shown in FIG. 4. The computer 32 is preferably a central processing unit for the vehicle, which evaluates both acoustic data and data from surroundings detection sensors in the vehicle assistance system, and preferably propagates an artificial neural network with this data.

In the first step V1 shown in FIG. 4, at least one ambient noise is recorded from the surroundings of the vehicle 1, e.g. with one of the microphones 11a, 11b, 11c, or 11d. Depending on the ambient noise, a position of the sound source in relation to the vehicle 1 is determined in step V2. A direction of movement of the sound source in relation to the vehicle 1 is determined as a function of the ambient noise in step V2b. Based on the position and the direction of movement, a dangerous situation is anticipated in step V3. Depending on the dangerous situation, a signal for the danger situation is generated in step V4. Subsequently, the signal is output such that the deaf driver 2 can perceive it in step V5a, in order to assist the driver 2 in reacting to the dangerous situation. The output takes place by means of the first output interface 12. The signal is output to the vehicle control device in step V5b, which can be carried out simultaneously with step V5a. The vehicle control device controls the vehicle 1 in a partially automated manner.

### REFERENCE SYMBOLS

1 vehicle
2 vehicle driver
3 vehicle control device
10 evaluation device
11 first input interface
11a first microphone
11b second microphone
11c third microphone
11d fourth microphone
12 first output interface
13 second output interface
14 second input interface
15 surroundings detection sensor
16 user device
20 assistance system
30 computer program
31 memory
32 computer
V1-V5b method steps

1. An evaluation device for a vehicle for assisting a hearing impaired vehicle driver, comprising
a first input interface for receiving at least one ambient noise,
wherein the evaluation device is configured
to determine at least one position of the sound source in relation to the vehicle based on the ambient noise,
to anticipate a dangerous situation based on the movement of the vehicle in relation to the sound source, and
to generate a signal for the dangerous situation,
and
a first output interface, configured to output the signal such that the hearing impaired vehicle driver can perceive it, in order to assist the vehicle driver in reacting to the dangerous situation.

2. The evaluation device according to claim 1, wherein the first input interface is an interface for at least one microphone that can be placed on the vehicle, preferably four microphones that can be placed on the vehicle, wherein, particularly preferably, a first microphone is placed on the front of the vehicle, a second microphone is placed on the back of the vehicle, a third microphone is placed on a first side of the vehicle and a fourth microphone is placed on a second side of the vehicle.

3. The evaluation device according to claim 1, wherein the first output interface is an interface, preferably a user interface, which outputs the signal for visual and/or tactile perception.

4. The evaluation device according to claim 1, wherein the first output interface is an interface that outputs the signal for acoustic perception.

5. The evaluation device according to claim 1, wherein the computer program is an artificial neural network trained to generate a signal for the dangerous situation, and the evaluation device is configured to forward propagate the artificial neural network with the at least one ambient noise.

6. The evaluation device according to claim 1, wherein the evaluation device comprises a second output interface for outputting the signal to a vehicle control device for an at least partially automated control of the vehicle.

7. The evaluation device according to claim 1, wherein the evaluation device comprises a second input interface for receiving data from at least one surroundings detection sensor and wherein the evaluation device is configured to combine the data from the at least one surroundings detection sensor with the at least one ambient noise with regard to the perception of the surroundings of the vehicle.

8. An assistance system for hearing impaired vehicle drivers, comprising
at least one microphone that can be placed on a vehicle for recording at least one ambient noise,
an evaluation device according to claim 1, and
a user device of the vehicle,
wherein the first input interface receives the ambient noise recorded by the microphone, and
the first output interface outputs the signal to the user device in order to assist the vehicle driver in reacting to the dangerous situation.

9. The assistance system according to claim 8, wherein the user device is a display device, preferably an infotainment system and/or a head up display, a touch device, preferably a steering wheel and/or a gas pedal, and/or an audio device, preferably a speaker and/or speaker system.

10. A use of an assistance system according to claim 8 in a vehicle.

11. A method for assisting a hearing impaired vehicle driver while driving a vehicle, comprising the following steps:
receiving at least one ambient noise from the surroundings of the vehicle (V1),
determining at least one position of the sound source in relation to the vehicle based on the ambient noise (V2a),
anticipating a dangerous situation based on a movement of the vehicle in relation to the sound source (V3),
generating a signal for the dangerous situation (V3),
outputting the signal such that it can be perceived by the hearing impaired vehicle driver in order to assist the driver in reacting to the dangerous situation (V5a).

12. The method according to claim 11, wherein a direction of movement of the sound source in relation to the vehicle is determined based on the ambient noise (V2b).

13. The method according to claim 11, wherein the signal is output to a vehicle control device and the vehicle control device controls the vehicle in an at least partially automated manner (V5b).

14. The method according to claim 11, wherein an evaluation device according to claim 1, or an assistance system according to claim 8, is used to execute the method.

15. A computer program for assisting a hearing impaired vehicle driver that is configured to be uploaded into the memory of a computer, and which comprises software code segments with which the method according to claim 11 is executed when the computer program is running on the computer.

16. The evaluation device according to claim 2, wherein the first output interface is an interface, preferably a user interface, which outputs the signal for visual and/or tactile perception.

17. The evaluation device according to claim 2, wherein the first output interface is an interface that outputs the signal for acoustic perception.

18. The evaluation device according to claim 2, wherein the computer program is an artificial neural network trained to generate a signal for the dangerous situation, and the evaluation device is configured to forward propagate the artificial neural network with the at least one ambient noise.

19. The evaluation device according to claim 2, wherein the evaluation device comprises a second output interface for outputting the signal to a vehicle control device for an at least partially automated control of the vehicle.

20. The evaluation device according to claim 2, wherein the evaluation device comprises a second input interface for receiving data from at least one surroundings detection sensor and wherein the evaluation device is configured to combine the data from the at least one surroundings detection sensor with the at least one ambient noise with regard to the perception of the surroundings of the vehicle.
